(19) United States
(12) Patent Application Publication
(10) Pub. No.: US 2012/0031207 A1
(43) Pub. Date: Feb. 9, 2012

(54) Wave energy converter

(76) Inventor: Usher Meyman, Brooklyn, NY (US)

(21) Appl. No.: 12/806,049

(22) Filed: Aug. 5, 2010

(51) Int. Cl. F16H 21/00

(52) U.S. Cl. 74/25

(57) ABSTRACT

A wave energy converter comprises a space truss having vertical frames between which a plurality of floats are placed, generators and means for converting the vertical reciprocating movement of the floats into a unidirectional rotation of the of the generator shaft on which a flywheel is fixed. This means has a gearing converting alternate rotation of its input shaft into unidirectional rotation of its output shaft provided with an overrunning clutch on which the flywheel is mounted. The flywheel stabilizes the rotation of the generator shaft and together with the overrunning clutch lets the float to sink to initial position.

### BACKGROUND OF THE INVENTION

The present invention relates to a wave energy converter (WEC).

WECs are known in the art and disclosed, for example, in the U.S. Pat. No. 1,567,470. This WEC has an above water horizontal platform and floats connected to the latter by crossed links and toothed bars pivoted to the floats. However, it is non-operable because the distance between ends 30 and 32 of the crossed links must, but cannot change during supposed vertical movement of the float, and because the bars 7 must, but cannot tilt during its undulating movement.

### SUMMARY OF THE INVENTION

Accordingly, it is an object of the present invention to provide a wave energy converter which avoids the disadvantages of the prior art.

In keeping with this object and with others which will become apparent hereinafter, one feature of the present invention resides, briefly stated, in a WEC which has a plurality of vertical frames between which a plurality of floats are mounted, and means for transmitting vertical reciprocating movement of each float into unidirectional rotation of an electric generator provided with a flywheel which is mounted on an overrunning clutch installed on a drive shaft.

The novel features of the invention are set forth in the appended claims. The invention itself, however, will be best understood from the following description and drawings.

### BRIEF DESCRIPTION OF THE DRAWINGS

FIGS. 1, 2 and 3 are schematic views showing floats on waves.

FIGS. 4 and 5 are mechanical diagrams of a gearing.

FIGS. 6 and 7 show rows of the floats transverse and parallel to the wave front.

FIG. 8 shows the contour of a frame transverse to the wave front.

FIGS. 9, 10, 13 and 14 are fragmentary sectional views of the WEC in different scales.

FIG. 11 is a mounting scheme of the WEC.

FIG. 12 shows the shape of the WEC.

FIG. 15 is a plan view of the WEC.

### DESCRIPTION OF PREFERRED EMBODIMENTS

A float 1 (FIG. 1) intended for utilizing in the inventive WEC is filled up with surrounding water because of openings 2 and 2′ for increasing its weight (instead of a ballast), i.e. for its partial submerging. The opening 2 may be closed by a check valve 3.

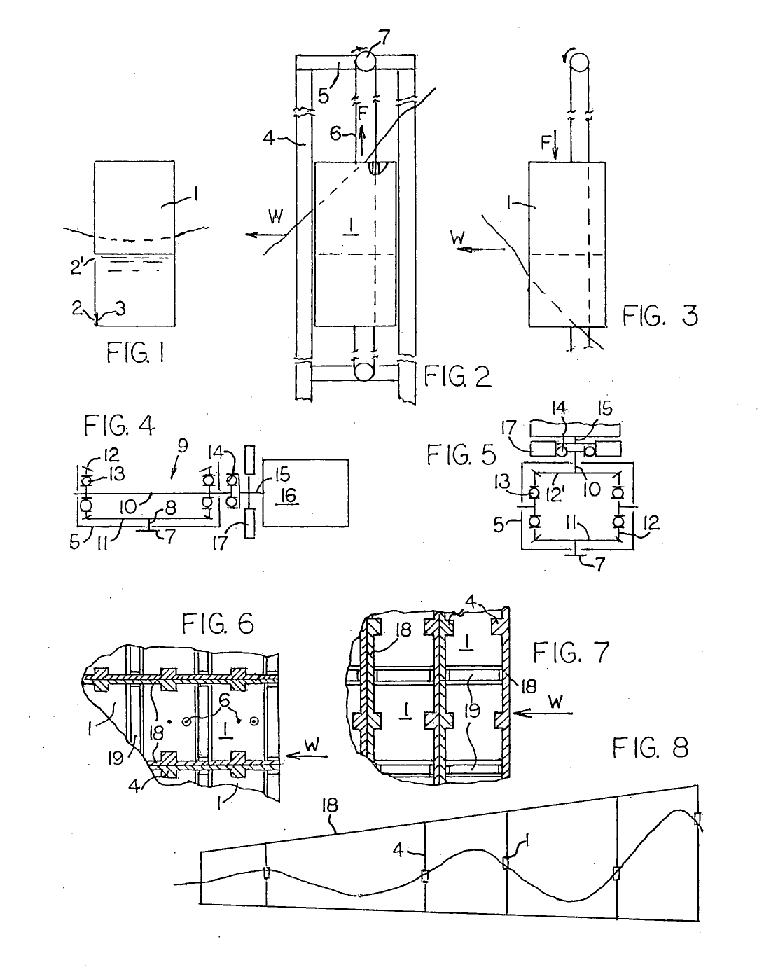

Suspended between pillars (or pales) 4 (FIG. 2) on a beam 5 by a chain (or rope) 6 engaged with upper and lower sprockets (or pulleys) 7, the float is submerging and pushing upward by an incoming wave W with a force F (proportional to resistance of a generator to rotate) which rotate the sprockets clockwise (and pushes pillars upward). After the crest of the wave W passes the float 1 (FIG. 3), the latter rotates the sprockets 7 counterclockwise (and pulls the pillars downward). Thus, the chain 6 and sprockets 7 fixed on a shaft 8 (FIG. 4), represent a means which converts the vertical reciprocating movement of the float 1 into rotation of the shaft 8. The known in the art gearing 9 is installed for converting alternate rotation of its input shaft 8, into unidirectional rotation of an output shaft 10.

A pinion 11 fixed on the input shaft 8 of the gearing 9 is engaged with bevel gears 12 mounted on overrunning clutches 13 which are seizing in the opposite direction on the shaft 10. Therefore the rotation of the sprocket 7 in the opposite directions is converted into unidirectional rotation of the output shaft 10. An overrunning clutch 14 may be mounted between the shaft 10 and a shaft 15 of a generator 16. A flywheel 17 fixed on the shaft 15, stabilizes the rotation of the latter when the crests or throats pass the float, i.e. when the sprocket 7 turns slowly, and lets the float to sink on the throat to initial depth (FIG. 1).

Another mechanical diagram of the gearing is shown in FIG. 5. The bevel gears 12 mounted on the overrunning clutches 13, are engaged with a bevel gear 12′ fixed on the output shaft 10. The overrunning clutch 14 may be mounted between the shaft 10 and the flywheel 17 fixed on the generator shaft 15.

The waves spend energy for lifting the float, i.e. for turning the shaft of the generator, which signifies that their height lessens. Their height lessens also when the float emerges (FIG. 3), because surrounding water has to fill the freeing volume up. If the inventive WEC has a plurality of the floats 1 placed in rows between frames 18 (FIG. 6) transverse to the wave front, the waves W will take the contour shown in FIG. 8, while the contour of the frames 18 may be trapezoidal. Just several floats and pillars are conditionally shown for clarity. The frames 18 (FIG. 7) may be parallel to the wave front and have therefore the rectangular contour the height of which decreases in the direction, shown by the arrow W. The frames are connected with one another by cross-bars 19 forming the space truss.

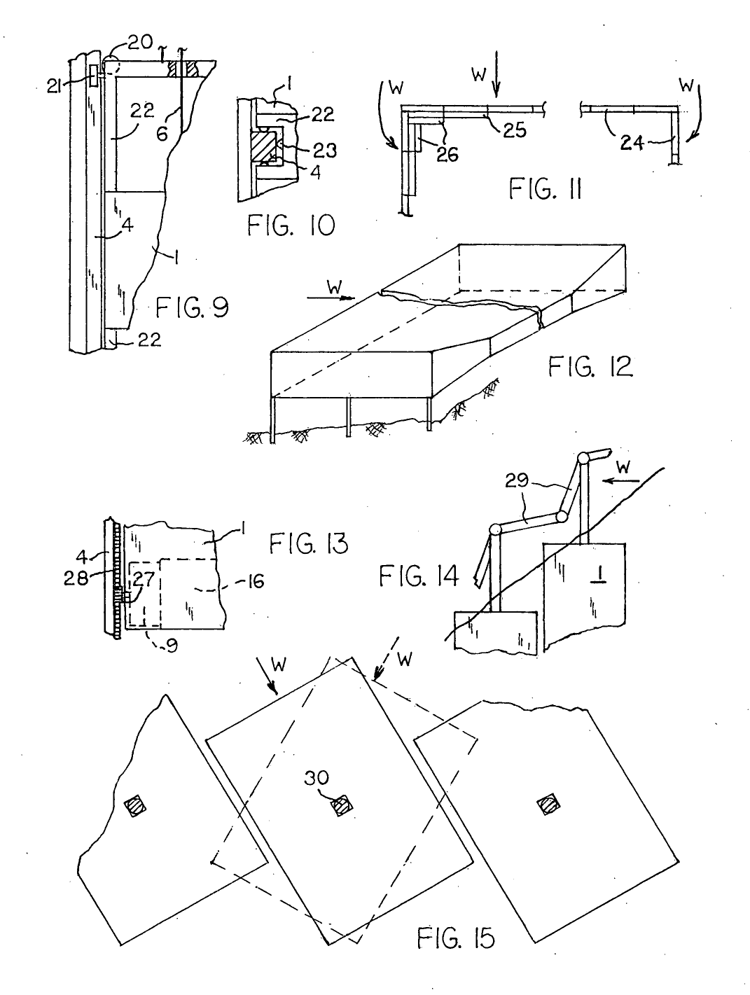

Although the friction between the float 1 and pillars 4 is overcoming by some additional submerging of the float, rollers 20 and 21 (FIG. 9) may be utilized to diminish the friction. They may be mounted on posts 22 increasing the resistance of the float to cocking. Instead of rollers, bolls 23 (FIG. 10) may be installed.

The mounting of the WEC near shore may be started with the highest rectangular (or square) front and flank sections 24 (FIG. 11) of suitable dimensions collected on the beach. They can generate electric energy immediately. Each next row of attaching sections (25, 26 etc) has lessened (comparatively to the previous row) height so as the WEC will obtain the shape of broadened amphitheater the contours of which are shown in FIG. 12. The WEC mounted in the open sea may have the shape of elongated or circular stadium. It may be mounted around an island. The WEC mounted around towers of wind energy converters will make electrical energy up during a swell, i.e. when the wind converter does not function, or vice versa, which diminishes irregularity of the provision of energy.

The inventive WEC collected from light (hollow, plastic) parts of the space truss, may be made floatable, moored by any suitable conventional means and may be provided with propeller units. The heavy generators 16 (FIG. 13) and gearing 9 are installed in the floats 1 for guaranteeing of stability of the WEC. The vertical reciprocating movement of the float is transmitted to the gearing 9 by a gear 27 engaged with a rack 28 provided on the pillar 4. The electric current is transmitted to the beach by conductors and contacts hermetically closed in swinging links 29 (FIG. 14) which working life is many times longer than the life of fast rotating corresponding parts of the generator.

There is some disparity between forces F which the highest wave applies to the first floats in the row which is transverse to the wave front, and forces F of the lowered passed wave. This disparity is balanced by some additional submerging of the rest of the floats so as heeling of the WEC is insignificant. Pontoons (not shown) fixed to the rear portions of the space truss may diminish heeling.

The floating WEC mounted around towers 30 (FIG. 15) of the wind energy converters, may be provided with means for their turning, e.g. propeller units.

The main advantages of the described WEC are: almost complete capture energy of the incoming waves; a short period of construction and provision energy from the very beginning of construction; it may be mounted almost everywhere or towed to a place of utilization; a low cost of parts each producing in huge amount, especially for long (for example 1 km) and several WEC.

The invention is not limited to the details shown since various modifications and structural changes are possible without departing in any way from the spirit of the present invention.

What is claimed is:

1. A wave energy converter, comprising a space truss having vertical frames and pillars and upper and lower portions; a plurality of floats placed between said frames; electrical generators each having a shaft and a flywheel; a means for converting the vertical reciprocating movement of each said float into unidirectional rotation of said shaft consisting of a gearing having input and output shafts, an overrunning clutch mounted between said output shaft and a member of a pair consisting of said flywheel and generator shaft, and of a means for converting the movement of said float into alternate rotation of said input shaft.

2. The wave energy converter as defined in claim 1, wherein said means for converting the movement of said float into alternate rotation of said output shaft consists of an upper sprocket fixed on said input shaft, a lower sprocket mounted on said lower portion of said space truss, a chain connected with said float and engaged with said sprockets.

3. The wave energy converter as defined in claim 1, wherein said means for converting the movement of said float into alternate rotation of said output shaft consists of a rack provided on said pillar and a gear engaged with said pillar and fixed on said input shaft of said gearing installed together with said generator in said float.

4. The wave energy converter as defined in claim 1, wherein said gearing has a pinion fixed on said input shaft, bevel gears engaged with said pinion and mounted on overrunning clutches installed on said output shaft.

5. The wave energy converter as defined in claim 1, wherein said overrunning clutch is mounted between said output shaft and flywheel.
